(19) United States
(12) Patent Application Publication
(10) Pub. No.: US 2006/0037983 A1
(43) Pub. Date: Feb. 23, 2006

(54) Safety seat pocket

(76) Inventor: Darren Leonard Charles Saxton, Stafford, VA (US)

Correspondence Address: NIXON PEABODY, LLP, 401 9TH STREET, NW, SUITE 900, WASHINGTON, DC, 20004-2128, US

(21) Appl. No.: 10/921,910

(22) Filed: Aug. 20, 2004

(51) Int. Cl. B60R 7/00

(52) U.S. Cl. 224/275

(57) ABSTRACT

The present invention provides a safety seat pocket for use in a public transport vehicle or a general seating area, where the safety seat pocket has at least a front panel that is constructed of a flexible, transparent material. With transparent panels, items, such as unsanitary items, contraband, and weapons, in or behind the seat pocket can be visually identified easily and immediately. The present invention also provides a fastening means that securely attaches to any interior surface of a passenger vehicle in a manner that also allows it to be easily detached and replaced. As a result, the seat pocket is easily disposable but can be used in the environment of a passenger vehicle. Moreover, the panels of the safety seat pocket are also securely joined to accommodate the storage of heavy items. The present invention may also be produced in a tear-off roll supply; the seat backs are easily removed from the roll, allowing fast and efficient replacement.

### BACKGROUND OF THE INVENTION

1. Field of Invention

This invention relates to pockets, also known as seat pockets, used mainly for storage on public transport vehicles, but may also be used in connection with general public seating.

2. Description of Related Art

Seat pockets are used for easy-access storage in passenger transportation vehicles, such as airplanes, trains, buses, ferries, and taxi cabs. For example, seat pockets on passenger airplanes generally allow storage for airline safety cards, magazines, and airsickness bags as well as personal belongings. Seat pockets are often located on the backs of passenger seats, but may be fixed to other interior surfaces of the passenger vehicle.

Current seat pockets are generally made of cloth, colored plastic, leather, or other opaque material. As a result, air crews, cleaning crews, and passengers are not able to identify the contents of a seat pocket quickly. Safety and health problems arise when items not intended for storage are placed into these seat pockets and are not removed. Examples of such items have included syringes and needles, used facial tissue, used airsickness bags, used chewing gum, uneaten food, and used baby diapers. Various weapons have also been concealed in seat pockets. Furthermore, the opaque material of the seat pockets often conceals personal belongings and causes passengers to leave them behind unintentionally. Also, seat pockets contain important materials such as airline safety cards or airsickness bags. The opaque material makes it more difficult to determine when these items are missing from seat pockets and need to be supplied.

Current seat pockets can also make cleaning difficult. Cloth seat pockets, especially, can become stained and can become filthy when they soak up liquids or when dirt and crumbs are trapped in the cloth fibers. In addition, seat pockets are intended to be permanently fixed to an interior surface or seat back. In some cases, the seat pocket is part of the entire seat covering. As a result, it may be difficult to reach dirt and crumbs that are trapped at the bottom of the pockets. Moreover, fixed pockets may be difficult to replace when substances, such as used chewing gum, cannot be completely removed from the seat pocket material.

Castaldo (U.S. Patent D436,031 S) discloses an ornamental design for a theatre trash receptacle that is attachable to the rear of a movie theatre seat. Castaldo teaches the attachment of a bag structure to a seat back, but it does not disclose the type of material used to construct the bag structure. More particularly, it does not teach the use of a transparent material. In addition, Castaldo discloses the use of an attachment means that affixes the upper, center portion of the bag to the seat back. The attachment does not secure the entire bag and may allow the bottom portion of the bag to move in relation to the seat back. Although such an attachment may be sufficient in a movie theatre, it may be less suitable for other environments, such as a public transport vehicle.

Sartena (U.S. Pat. No. 6,637,485 B1) discloses a handbag that employs a covered transparent wall. Sartena teaches the use of one flexible transparent panel joined to a second opaque panel to form a handbag. In addition, an additional panel is used to cover the transparent wall. With this covering panel, the Sartena handbag does not provide immediate visual access to contents handbag. In addition, even when the covering panel is lifted, there is no visual access through the entire handbag to any items on the other side.

Mitchell (U.S. Pat. No. 3,151,649) discloses an automobile supported carrying pouch with a transparent front cover to allow visual access to contents in a front pocket of the pouch. The Mitchell invention provides easy access storage of items in a passenger vehicle. The pouch can only be attached to the interior surface with a molding or other feature that can engage a linearly continuous bead along the top edge of the pouch. There may be no suitable support to engage the bead in many public transport vehicles, especially on seat backs. Moreover, Mitchell does not disclose a fastening means that attaches the bottom or sides of the pouch to the seat back. In addition, the invention only uses one transparent front panel, obscuring the contents of items on the other side of the pocket. Furthermore, this pouch is personal to an individual in the vehicle who is likely to know its contents and who will likely return to the same seat on numerous occasions such that anything left behind will later be easily recovered.

### BRIEF SUMMARY OF THE INVENTION

The current art provides no easy-access storage device for use on passenger transportation vehicles wherein items in and behind the storage device can immediately be visually identified and wherein the storage device is securely attached but can be easily detached when desired and replaced. To resolve the absence of such a storage device, the present invention provides a transparent, inexpensive, and quickly replaceable seat pocket, also known as a safety seat pocket. As with current seat pockets which are often attached to other walls and surfaces of the public transport vehicle or other public seating area, the use of the safety seat pocket is not limited to the back of the seats.

To overcome the limitations of the prior art, the present invention provides a seat pocket with panels that are constructed of a flexible, transparent material, which may include, but is not limited to, a flexible, clear plastic, a mesh-like material, or a sufficiently transparent fabric or fabric-like material. With completely transparent panels, unsanitary items, contraband, and weapons in or behind the pocket can be viewed clearly. In addition, passengers or patrons will be able to identify personal belongings in the pocket that may otherwise be left behind unintentionally. Also, maintenance personnel can determine when seat pockets are missing important materials such as airline safety cards or airsickness bags that need to be supplied.

The safety seat pocket may simply use front and back panels that are joined at the bottom and side edges to create a pocket. Alternatively, the safety seat pocket may use multiple panels. For instance, the front and back panels may be joined to opposite edges of additional side and bottom panels. The safety seat pocket may also use additional panels to create a multiplicity of smaller interior or exterior pockets. The object of the present invention is met as long as a transparent material is used for all panels and all items in and behind the seat pocket are immediately visible.

To further overcome the limitations of the prior art, the present invention is securely attached to any interior surface of a passenger vehicle in a manner that also allows it to be easily detached and replaced. The safety seat pocket may be fastened to an interior surface of the passenger vehicle by twist style fasteners, clips, hooks, hook and loop fasteners (Velcro), snaps, buttons, or other means that allow fast, easy installation of the pocket. The fastening device will also generally not require the use of tools. As a result, once unsanitary or undesired contents are identified easily through the transparent panels of the safety seat pocket, the attached safety seat pocket can be quickly and conveniently removed, discarded, and replaced with a new clean safety seat pocket.

To permit the use of the safety seat pocket in the environment of a passenger vehicle, the fastening device must be sufficiently secure to ensure that the safety seat pocket does not become inadvertently detached when it is being used, while the vehicle is moving, or when it comes into contact with passenger movement. The safety seat pocket must not move, shift, or become detached while passengers are placing or removing items from the pocket, especially when heavier items, such as laptops or books, are placed in the pocket. Also, objects and items in an airplane cabin may be subject to sudden forces when the airplane is in flight. In addition, passengers moving to and settling into their seats often come into contact with seat pockets attached to the seats in the row in front of them. The fastening device of the present invention ensures that the seat pocket will remain safely attached until intentionally removed. To do so, at least two sides of the safety seat pocket will generally need to be secured to the seat back or interior surface, for instance at the top and bottom and/or the left and right sides.

The panels of the safety seat pocket are also securely joined to accommodate the storage of heavier items. The methods for joining the panels may include heat sealing, using adhesives, gluing, stitching, stapling, taping, or any other suitable approach that will prevent separation of joined panels.

The present invention can be produced in varying sizes to accommodate the seat sizes or surfaces of varying vehicles or public seating areas. For example, the back of a seat on a passenger airplane may accommodate a seat pocket that is approximately 13 inches from side to side and 24 inches from top to bottom. In addition, the present invention may be packaged and shipped to make a supply of safety seat pockets easy to store and dispense. For example, the safety seat pockets may produced in convenient tear-off rolls to allow fast and efficient replacement. Further, the safety seat pockets can be embossed or otherwise provided with a logo or other indicia as necessary or desired.

### BRIEF SUMMARY OF THE DRAWINGS

FIG. 1 illustrates a top elevational view of a particular embodiment of the safety seat pocket;

FIG. 2 illustrates a front elevational view of the particular embodiment of the safety seat pocket;

FIG. 3 illustrates a rear elevational view of the particular embodiment of the safety seat pocket;

FIG. 4 illustrates a top elevational view of an alternative embodiment of the safety seat pocket;

FIG. 5 illustrates a front perspective view of the alternative embodiment of the safety seat pocket;

FIG. 6 illustrates a perspective view of another alternative embodiment of the safety seat pocket;

FIG. 7 illustrates an embodiment of the safety seat pocket with an additional flexible to create a safety seat pocket with a larger bottom;

FIG. 8 illustrates an embodiment of the safety seat pocket with a transparent panel as a separator inside the pocket; and

FIG. 9 illustrates a perspective view of another embodiment where a series of safety seat pockets are connected with perforations to form a tear-off roll for dispensing the safety seat pocket.

### DETAILED DESCRIPTION OF THE INVENTION

The following presents a detailed description of the safety seat pocket which provides an easy-access storage device for use on passenger transportation vehicles or in connection with public seating in general wherein items in and/or behind the storage device can immediately be visually identified and wherein the storage device is securely attached but can be easily detached when desired and replaced.

The panels in embodiments of the present invention may be created from any flexible and transparent materials, including, but not limited to, clear plastic, a mesh-like material, or a sufficiently transparent fabric or fabric-like material. The shapes of these panels may also vary in order to create different shapes for the safety seat pocket. The panels may also joined by numerous methods, including, but not limited to, heat sealing, using adhesives, gluing, stitching, stapling, and taping. Furthermore, the safety seat pocket is attached to a surface according to any appropriate technique, including, but not limited to, twist style fasteners, clips, hooks, hook and loop fasteners (Velcro), snaps, or buttons.

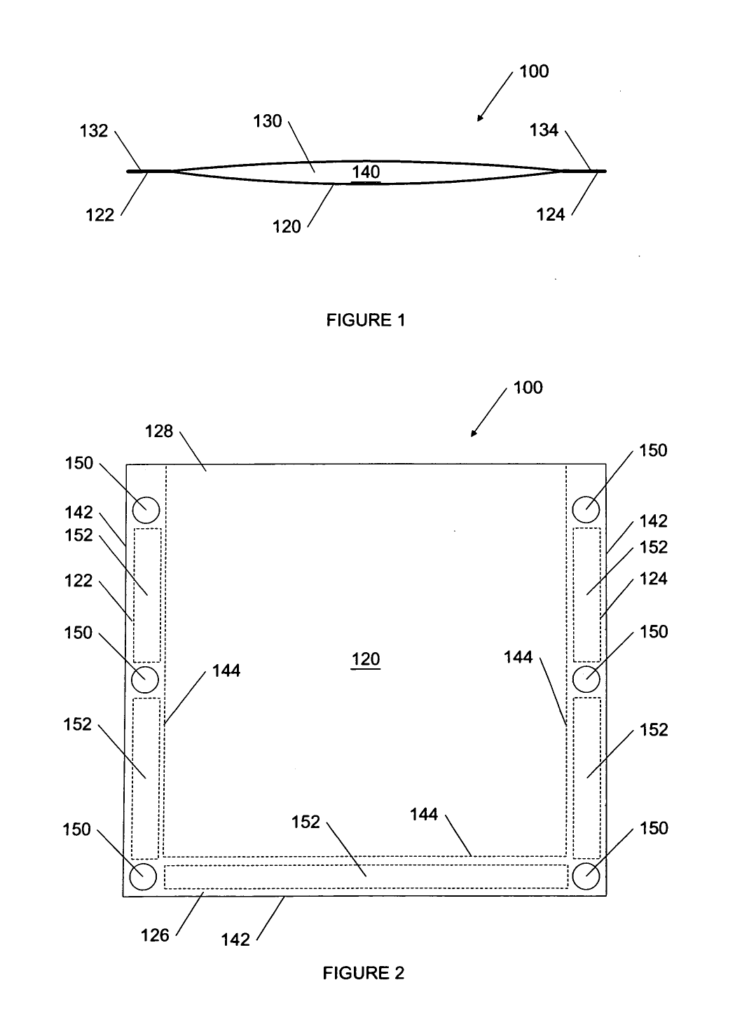

FIG. 1 of the Drawings illustrates a top elevational view of a particular embodiment of the safety seat pocket 100. Safety seat pocket 100 has a front panel 120 and a back panel 130, both made of equally-sized flexible, transparent sheets. The transparent sheets provide immediate visual access through the front panel 120 to the interior of safety seat pocket 100 and through the back panel 130 to the other side of safety seat pocket 100. While this, and other embodiments referred to hereinbelow, refer to the seat pocket 110 as having both transparent front and back panels, the back panel need not necessarily be transparent, Further, portions of the front panel may be opaque or solid as long as a sufficient transparent viewing window is maintained.

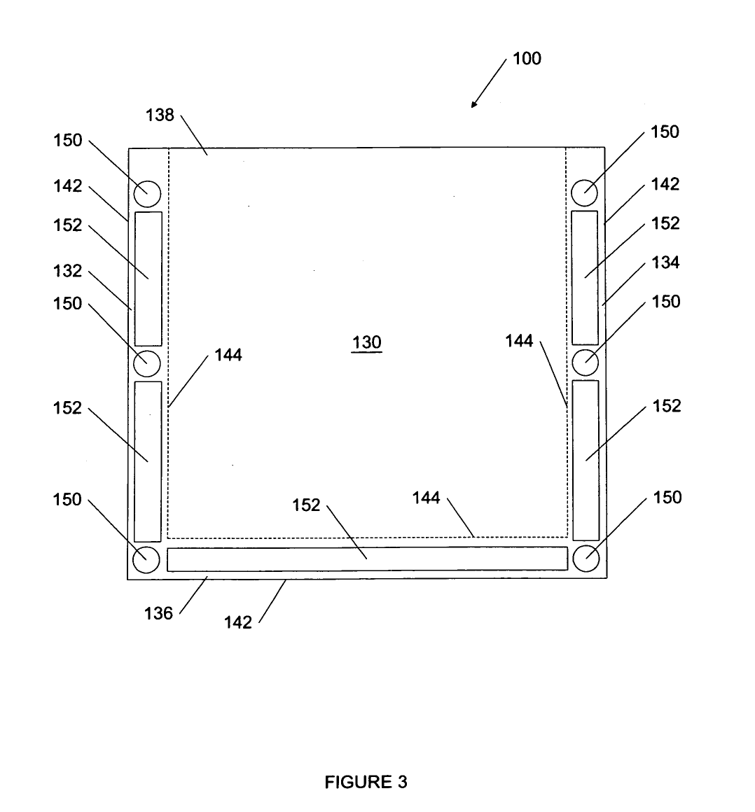

FIG. 2 of the Drawings illustrates a front elevational view of the particular embodiment of safety seat pocket 100. FIG. 3 of the Drawings illustrates a rear elevational view of the particular embodiment of safety seat pocket 100. As shown in FIGS. 1, 2, and 3, the sides 122 and 124 of the rectangular front panel 120 are joined to the sides 132 and 134 of the equally-sized rectangular back panel 130, respectively. The bottom 126 of the front panel 120 is joined to the bottom 136 of the back panel 130. The top 128 of the front panel 120 and the top 138 of the back panel 130 are not joined to create access to the pocket 140 of the safety seat pocket 100. The panels may be joined by heat sealing at the outer edge 142 and at an inner seam 144. However, as discussed above, other methods are suitable for joining the panels in the present invention.

FIG. 2 further illustrates grommet holes 150 along the sides of the safety seat pocket 100, reinforced with heat seals, providing passage through safety seat pocket 100 to allow fastening to a seat back by means of snaps, twist style fasteners, or other fastening devices. The present embodiment uses the grommet holes 150 in conjunction with hook and loop fasteners (Velcro) strips 152 attached along the sides of the back panel 130. However, the safety seat pocket may use either the grommet holes 150 or the Velcro strips 152 by themselves. Alternatively, other fastening methods are available to ensure that the present invention is securely attached on at least two sides but yet easy to remove and replace.

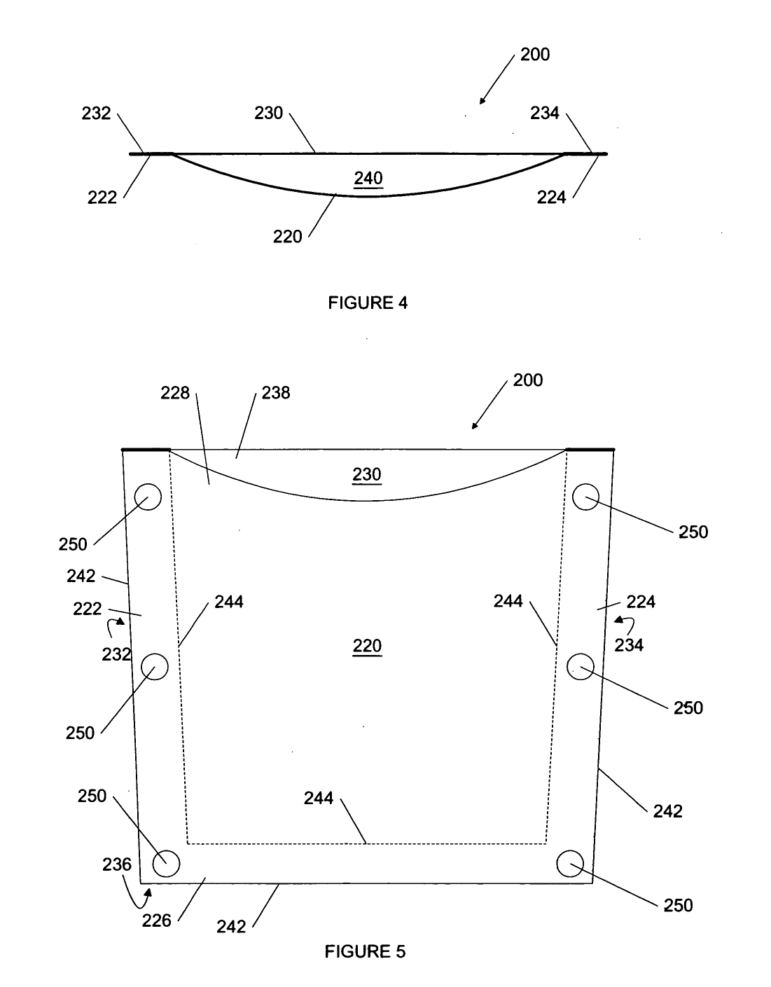

FIG. 4 of the Drawings illustrates a top elevational view of an alternative embodiment of the safety seat pocket. FIG. 5 of the Drawings illustrates a front perspective view of the alternative embodiment. As seen in FIGS. 4 and 5, the safety seat pocket 200 shares features of the previous embodiment, such as the grommet holes 250 and the heat sealed outer edge 242 and inner seam 244. However, it has a trapezoidal front panel 220 and a trapezoidal back panel 230. Furthermore, the top 228 of the front panel 220 is slightly longer than the top 238 of the back panel 230. The bottom 226 of the front panel 220 remains the same length as the bottom 236 of the back panel 230. When the sides 222 and 224 and the bottom 226 of the front panel 220 are joined to the sides 232 and 234 and the bottom 236 of the back panel 130, respectively, the difference in lengths between the top 228 of the front panel 220 and the top 238 of the back panel 230 will create larger access to the pocket 240 of the safety seat pocket 200. The difference in lengths can be adjusted to create the desired amount of access at the top of pocket 200.

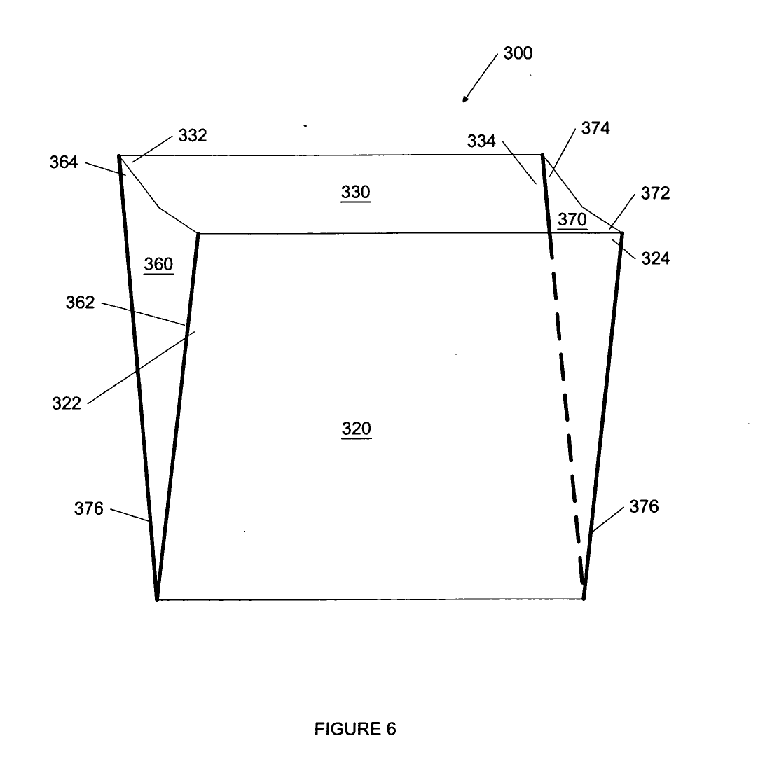

FIG. 6 of the Drawings illustrates a perspective view of another alternative embodiment of the safety seat pocket. This embodiment also allows sufficient access to the pocket through the top of the safety seat pocket. Referring to FIG. 6, the safety seat pocket 300 has a four-sided front panel 320, a four-sided back panel 330, and triangular side panels 360 and 370, all made of flexible, transparent sheets.

The side 322 of front panel 320 is joined to the side 362 of the side panel 360, and the side 332 of the back panel 330 is joined to the side 364 of the side panel 360. Similarly, the side 324 of the front panel 320 is joined to the side 372 of the side panel 370, and the side 334 of the back panel 330 is joined to the side 374 of the side panel 370. The panels may be joined by heat sealing. However, as discussed above, other methods are suitable for use in the present invention. In addition, the safety seat pocket may be removably attached to an interior surface through any appropriate means, including, but not limited to, those described above.

Additionally, the embodiment shown in FIG. 6 employs the devices 376 that create a bias to keep the opening at the top in closed position. The devices 376 include two metal wires, each one bent at the bottom of the storage pocket and fixed to a side of the front panel 320 and a side of the back panel 330. The normal position of the metal wires is in a closed V position. To open the pocket, a sufficient force must be applied to keep the metal wires in an open V shape. Other devices, however, such as springs or elastic, may be employed to create a bias to keep the access opening of the present invention closed.

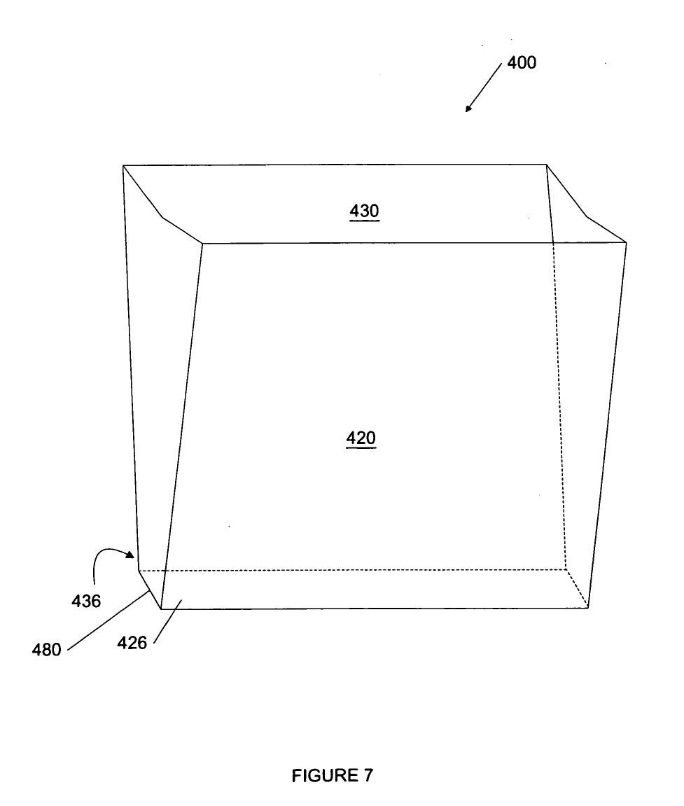

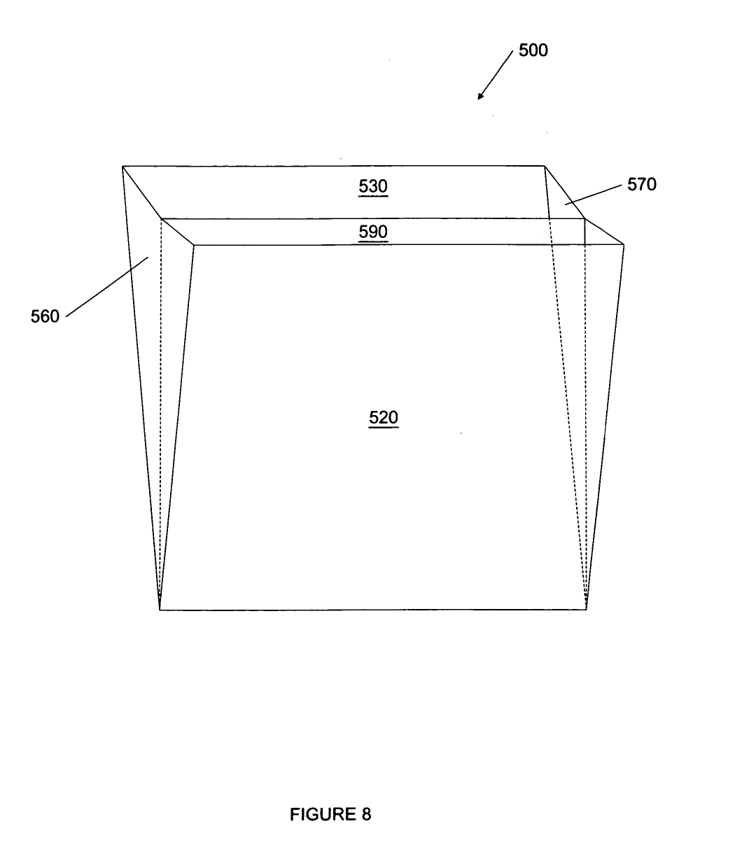

The present invention further provides the use of additional panels to create various shapes for the safety seat pocket. For instance, the perspective view of FIG. 7 of the Drawings illustrates safety seat pocket 400 with an additional flexible, transparent panel 480 joining the bottom edges 426 and 436 of the front panel 420 and the back panel 430, respectively, to create a safety seat pocket with a larger bottom. FIG. 8 of the Drawings has a front panel 520, a back panel 530, and side panels 560 and 570, but it also illustrates the use of a transparent, flexible panel 590 in the safety seat pocket 500 to create a separator inside the pocket.

As an alternative to joining the separated bottom edges of the front and back panels as seen in the embodiments above, the front and back panels may be constructed from the same sheet of material, and the bottom of the pocket may be formed by folding the sheet of material. In other words, the bottom edges of the front and back panels will already be joined as a part of the same sheet of material. This approach will eliminate the added step of joining separated bottom edges. In addition, it may allow the safety seat pocket to accommodate heavier objects since any possible weakness in the joining process will be avoided.

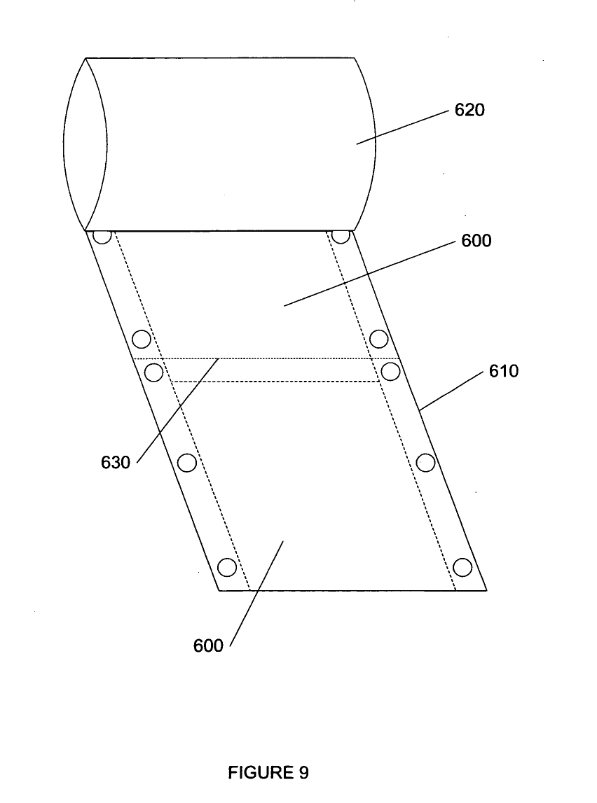

FIG. 9 of the Drawings illustrates a perspective view of another embodiment of the present invention wherein a series of safety seat pockets 600 are connected to form a continuous sheet 610 and wherein the sheet creates a tear-off roll 620 to dispense the safety seat pocket. Easy tear perforations 630 allow dispensing of a single safety seat pocket 600.

While the present invention has been described in connection with a number of exemplary embodiments and implementations, the present invention is not so limited but rather covers various modifications and equivalent arrangements, which fall within the purview of the appended claims.

What is claimed is:

1. A public storage pocket for use on public transport vehicles, said public storage pocket comprising:
a front panel formed of at least one flexible transparent material;
a back panel formed of at least one flexible material, side edges of said back panel being joined to side edges of said front panel, and bottom edge of said back panel being joined to bottom edge of said front panel, creating a receptacle with an access opening at the top of said receptacle; and
a fastening means fixed to said receptacle, said fastening means removably attaching at least two sides of said receptacle to a surface.

2. The public storage pocket according to claim 1, wherein a side edge of said front panel and a side edge of said back panel are joined by being connected to opposing edges of a side panel, said side panel being formed of at least one flexible transparent material.

3. The public storage pocket according to claim 1, wherein said bottom edge of said front panel and said bottom edge of said back panel are joined by being connected to opposing edges of a bottom panel, said bottom panel being formed of at least one flexible transparent material.

4. The public storage pocket according to claim 1, further comprising:
a biasing means fixed to said receptacle to keep said access opening in closed position.

5. The public storage pocket according to claim 1, further comprising:
additional panels joined to said receptacle, forming compartments in said receptacle, said additional panels being formed of at least one flexible transparent material.

6. The public storage pocket according to claim 1, wherein said at least one flexible transparent material is plastic.

7. The public storage pocket according to claim 1, wherein said front panel and said back panels are joined by heat sealing.

8. The public storage pocket according to claim 1, wherein said public storage pocket is connected in series with other public storage pockets, said connections being perforated.

9. The public storage pocket according to claim 1, wherein said public storage pocket is marked with a logo.

10. A method for making a public storage pocket on public transport vehicles, said method comprising:
forming a front panel of at least one flexible transparent material;
forming a back panel of at least one flexible material;
joining side edges of said back panel to side edges of said front panel;
joining bottom edge of said back panel to bottom edge of said front panel; and
fixing a fastening means to said public storage pocket, said fastening means removably attaching at least two sides of said public storage pocket to a surface.

11. The method according to claim 10, wherein step of joining side edges of said back panel to side edges of said front panel further comprises:
connecting a side edge of said front panel and a side edge of said back panel to opposing edges of a side panel, said side panel being formed of at least one flexible transparent material.

12. The method according to claim 10, wherein step of joining bottom edge of said back panel to bottom edge of said front panel further comprises:
connecting said bottom edge of said front panel and bottom edge of said back panel to opposing edges of a bottom panel, said bottom panel being formed of at least one flexible transparent material.

13. The method according to claim 10, further comprising:
fixing a biasing means to said storage pocket to keep said access opening in closed position.

14. The method according to claim 10, further comprising:
joining additional panels to said public storage pocket to form compartments in said public storage pocket, said additional panels being formed of at least one flexible transparent material.

15. The method according to claim 10, wherein said at least one flexible transparent material is plastic.

16. The method according to claim 10, wherein said front panel and said back panels are joined by heat sealing.

17. The method according to claim 10, further comprising:
connecting said public storage pocket in series with other public storage pockets, said connection being perforated.

18. The method according to claim 10, further comprising:
marking said public storage pocket with a logo.

19. A public storage pocket for use in an area of general public seating, said public storage pocket comprising:
a front panel formed of at least one flexible transparent material;
a back panel formed of at least one flexible material, side edges of said back panel being joined to side edges of said front panel, and bottom edge of said back panel being joined to bottom edge of said front panel, creating a receptacle with an access opening at the top of said receptacle; and
a fastening means fixed to said receptacle, said fastening means removably attaching at least two sides of said receptacle to a surface.

20. The public storage pocket according to claim 19, wherein a side edge of said front panel and a side edge of said back panel are joined by being connected to opposing edges of a side panel, said side panel being formed of at least one flexible transparent material.

21. The public storage pocket according to claim 19, wherein said bottom edge of said front panel and said bottom edge of said back panel are joined by being connected to opposing edges of a bottom panel, said bottom panel being formed of at least one flexible transparent material.

22. The public storage pocket according to claim 19, further comprising:
a biasing means fixed to said receptacle to keep said access opening in closed position.

23. The public storage pocket according to claim 19, further comprising:
additional panels joined to said receptacle, forming compartments in said receptacle, said additional panels being formed of at least one flexible transparent material.

24. The public storage pocket according to claim 19, wherein said at least one flexible transparent material is plastic.

25. The public storage pocket according to claim 19, wherein said front panel and said back panels are joined by heat sealing.

26. The public storage pocket according to claim 19, wherein said public storage pocket is connected in series with other public storage pockets, said connections being perforated.

27. The public storage pocket according to claim 19, wherein said public storage pocket is marked with a logo.

28. A method of using a public storage pocket, said method comprising:
providing a public storage pocket having:
a front panel formed of at least one flexible transparent material;
a back panel formed of at least one flexible material, side edges of said back panel being joined to side edges of said front panel, and bottom edge of said back panel being joined to bottom edge of said front panel, creating a receptacle with an access opening at the top of said receptacle; and
a fastening means fixed to said receptacle, said fastening means removably attaching at least two sides of said receptacle to a surface;
attaching said public storage pocket to said surface; and
viewing the contents of said public storage pocket.

29. The method according to claim 28, wherein a side edge of said front panel and a side edge of said back panel are joined by being connected to opposing edges of a side panel, said side panel being formed of at least one flexible transparent material.

30. The method according to claim 28, wherein said bottom edge of said front panel and said bottom edge of said back panel are joined by being connected to opposing edges of a bottom panel, said bottom panel being formed of at least one flexible transparent material.

31. The method according to claim 28, wherein said public storage pocket further comprises:
a biasing means fixed to said receptacle to keep said access opening in closed position.

32. The method according to claim 28, wherein said public storage pocket further comprises:
additional panels joined to said receptacle, forming compartments in said receptacle, said additional panels being formed of at least one flexible transparent material.

33. The method according to claim 28, wherein said at least one flexible transparent material is plastic.

34. The public storage pocket according to claim 28, wherein said front panel and said back panels are joined by heat sealing.

35. The method according to claim 28, wherein said public storage pocket is marked with a logo.
